(19) United States
(12) Patent Application Publication
(10) Pub. No.: US 2019/0112211 A1
(43) Pub. Date: Apr. 18, 2019

(54) Method for Photocatalytic Ozonation Reaction, Catalyst for photocatalytic ozonation and Reactor Containing the Same

(71) Applicant: INSTITUTE OF PROCESS ENGINEERING, CHINESE ACADEMY OF SCIENCES, Beijing (CN)

(72) Inventors: Hongbin CAO, Beijing (CN); Yongbing XIE, Beijing (CN); Yuping LI, Beijing (CN); Yuxing SHENG, Beijing (CN)

(21) Appl. No.: 16/159,982

(22) Filed: Oct. 15, 2018

(30) Foreign Application Priority Data
Oct. 16, 2017 (CN) 201710958250.X

(51) Int. Cl. C02F 1/72; C02F 1/32; C02F 1/30; C02F 1/78; B01J 27/224; B01J 35/00

(52) U.S. Cl. CPC C02F 1/725; C02F 1/325; C02F 1/30; C02F 2101/34; B01J 27/224; B01J 35/004; C02F 1/78

(57) ABSTRACT

The present disclosure relates to a method for photocatalytic ozonation reaction, in which the silicon carbide material is used. By using the silicon carbide material for photocatalytic ozonation reaction, the present disclosure overcomes the problem of low photocatalytic efficiency of silicon carbide, utilizes photogenerated electrons therefrom with strong reducibility to reduce ozone molecules to efficiently produce hydroxyl radicals, so as to improve the oxidation capacity in the process. Whether visible light or ultraviolet light is coupled with ozone, the group has strong catalytic activity, moreover, the silicon carbide has low cost and good stability, which prolongs the life of catalyst for photocatalytic ozonation or device.

### CROSS-REFERENCE TO RELATED APPLICATIONS

This application claims priority to Chinese Patent Application No. 201710958250.X, filed on Oct. 16, 2017, the contents of which are incorporated herein in its entirety by reference.

### TECHNICAL FIELD

The present disclosure belongs to the technical field of wastewater and exhaust gas treatment, and specifically relates to a method for photocatalytic ozonation treatment of wastewater and exhaust gas, a catalyst for photocatalytic ozonation comprising silicon carbide material and a reactor for photocatalytic ozonation containing the same.

### BACKGROUND

Silicon carbide is a kind of semiconductor material with many advantages such as high thermal conductivity, large saturated electron transfer rate, high critical breakdown electric field and low dielectric constant. It is primarily used in fields of substrates of LED device, power electronic devices, substrates of radio-frequency microwave device, substrates of epitaxial graphene, etc., with favourable application prospects in various fields such as communications, power grid, aerospace, oil exploration and national defense and military. Besides, it is also gradually explored in the existing technologies to use silicon carbide as a catalyst, e.g. for photocatalytic decomposition of water to produce hydrogen or water pollutant degradation. However, its activity is proved to be very low. For example, generally acknowledged in the prior art, silicon carbide must support metal platinum when used as the catalyst for the photocatalytic decomposition of water to produce hydrogen. Likewise, it must be compounded with other semiconductor photocatalysts when used for photocatalytic treatment of water pollutants. Overall, the application prospect of silicon carbide seems extremely slim.

For photocatalytic reaction, the catalyst is expected to have superior electron-hole separation property, while for photocatalytic ozonation reaction, the ozone molecules themselves in the reaction system are favorable for electron-hole separation, thus the electron-hole separation property has inconspicuous function on improving catalytic effect.

During photocatalytic ozonation, ozone and incident light work together to generate hydroxyl radicals, achieving the goal of efficiently removing pollutants in wastewater and exhaust gas that are not easily oxidized by conventional oxidants. Photocatalytic ozonation technology mainly uses ultraviolet light as a light source, which has high manufacturing cost and a short stable service life. Therefore, the development of a catalyst for photocatalytic ozonation applicable to visible light may reduce the cost of photocatalytic ozonation. Nevertheless, the existing technologies mainly adopt materials such as WO₃ and C₃N₄ as catalysts for coupling visible light and ozone, in which the problems of low activity and instability are supposed to be further studied and improved.

Therefore, it has become a current focus of wide attention in the field to develop a catalyst for photocatalytic ozonation capable of using visible light as a light source to reduce the cost of photocatalytic ozonation.

### SUMMARY

On the basis of the aforesaid problems, the first object of the present disclosure is to provide a method for photocatalytic ozonation reaction, in which the silicon carbide material is used.

Silicon carbide, as a kind of semiconductor material, has characteristics such as wide band gap, high breakdown electric field, high thermal conductivity and large saturated electron transfer rate, with favourable application prospects in various fields including high-temperature devices, high-frequency devices, high-power devices, optoelectronics devices and anti-radiation devices. While the present inventors find that the silicon carbide material has photocatalytic ozonation activity, and the silicon carbide material can significantly induce the synergistic effect of ozone and visible light or ultraviolet light when it is used for photocatalytic ozonation reaction. Under the same conditions, the reaction rate of photocatalytic ozonation degradation of organics is much greater than the sum of the reaction rates of ozone catalytic oxidation and photocatalytic oxidation, which can significantly improve the reaction rate of photocatalytic ozonation. Meanwhile, since the silicon carbide material is a non-metallic material, with advantages of non-toxicity, light weight, high chemical stability, etc., it exhibits excellent activity and stability when used for photocatalytic ozonation reaction, and it can avoid catalyst deactivation and secondary pollution of metal dissolution from the source. In addition, the silicon carbide material imparts good thermal conductivity, oxidation resistance and mechanical strength to the catalyst for photocatalytic ozonation.

When the silicon carbide material is used as a catalyst for photocatalytic ozonation, the method for photocatalytic ozonation reaction comprises: under the condition of illumination, using a substance comprising the silicon carbide material as a catalyst, bringing the substance into contact with wastewater and/or exhaust gas, and at the same time, introducing a gas comprising ozone to carry out a reaction.

When the silicon carbide material is used as the catalyst for photocatalytic ozonation, it has a good response not only to ultraviolet light but also to visible light. Therefore, when selecting the silicon carbide as the catalyst for photocatalytic ozonation, either ultraviolet light or visible light even both can be selected as the incident light of photocatalytic ozonation.

The present disclosure has no specific limits to the type of silicon carbide, and any type of silicon carbide can be used in the present disclosure, exemplary silicon carbide including β-type silicon carbide, α-type silicon carbide, and the like, or a mixture of different types of silicon carbide available to those skilled in the art.

Preferably, the incident light of the illumination comprises ultraviolet light and/or visible light, preferably any one selected from the groups consisting of ultraviolet light with a wavelength range of 10-400 nm, visible light with a wavelength range of 400-820 nm, full-wavelength incident light with a wavelength range of 10-820 nm, and simulated sunlight with a wavelength range of 190-800 nm.

Illustratively, the wavelength of the incident light can be anyone selected from point values as listed below, or a range of values consisting of any point values selected therefrom:

8 nm, 15 nm, 30 nm, 60 nm, 80 nm, 95 nm, 100 nm, 110 nm, 130 nm, 160 nm, 180 nm, 195 nm, 200 nm, 210 nm, 230 nm, 260 nm, 280 nm, 295 nm, 300 nm, 310 nm, 330 nm, 360 nm, 380 nm, 395 nm, 400 nm, 410 nm, 430 nm, 460 nm, 480 nm, 495 nm, 500 nm, 510 nm, 530 nm, 560 nm, 580 nm, 595 nm, 600 nm, 610 nm, 630 nm, 660 nm, 680 nm, 695 nm, 700 nm, 710 nm, 730 nm, 760 nm, 780 nm, 795 nm, 800 nm, 810 nm, 830 nm, 860 nm, 880 nm, 895 nm and the like.

Preferably, the incident light of the illumination is of continuous-wavelength incident light or single-wavelength incident light, preferably continuous-wavelength incident light.

As a preferred technical solution, the catalyst in the present disclosure further includes a dopant, and the dopant preferably includes any one selected from the group consisting of metallic simple substances, metal oxides, silicon carbide, bismuth vanadate, and a combination of at least two selected therefrom.

The addition of the dopant can further improve the response of the silicon carbide to visible light, and improve the separation efficiency of photogenerated electrons and holes, thereby increasing the reaction rate of photocatalytic ozonation.

Preferably, the metal in the metallic simple substances or the metal oxides comprises any one selected from the group consisting of palladium, platinum, gold, silver, ruthenium, rhodium, iridium, manganese, copper, iron, cobalt, nickel, chromium, vanadium, molybdenum, titanium, zinc, tungsten, tin, and a combination of at least two selected therefrom.

The dopants can be doped in any manner that those skilled in the art can obtain, such as high temperature calcination after immersion, high temperature reduction after immersion, photochemical oxidation, photochemical reduction, etc., which are not specifically limited in the present disclosure.

Preferably, the dopant is doped on the surface of the silicon carbide material.

The catalyst in the present disclosure can further comprise additional functional ingredients, exemplarily a carrier on which the silicon carbide material is supported. The role of the carrier is to carry the catalyst so that it can be stably present, avoiding problems such as agglomeration. The present disclosure has no specific limit to the manner in which the silicon carbide material is supported on the carrier, and the carrier may be incorporated into the silicon carbide material by physical mixing roasting, high-speed ball milling, or other preparing processes, to which the present disclosure has no specific limit. The carrier of the present disclosure preferably comprises any one selected from the group consisting of nickel foam, molecular sieve, titanium dioxide, zinc oxide, tungsten trioxide, carbon nitride, and a combination of at least two selected therefrom.

Preferably, the silicon carbide material exists in the form of anyone selected from the group consisting of porous silicon carbide material sintered from solid silicon carbide powder, silicon carbide powder supported on the surface of a solid carrier, silicon carbide powder coated on the inner wall of a reactor, silicon carbide powder, and a combination of at least two selected therefrom.

Preferably, the silicon carbide powder material comprises any one selected from the group consisting of solid silicon carbide powder, mesoporous silicon carbide, silicon carbide nanorods, silicon carbide hollow spheres, and a combination of at least two selected therefrom.

Preferably, the method for preparing the silicon carbide material comprises any one selected from the group consisting of a template method, a sol-gel method, a carbothermic reduction method, a polycarbosilane cleavage method, a chemical vapor deposition method, a high-temperature thermal evaporation method, a combustion method, and a combination of at least two selected therefrom.

During the photocatalytic ozonation reaction, ozone may be introduced in the form of an ozone mixture, which is a mixed gas of oxygen and ozone generated by high-pressure ionization of a gas source composed of oxygen or clean air by an ozone reactor.

Preferably, the gas comprising ozone comprises ozone mixture, wherein the ozone mixture has an ozone concentration of 160 mg/L or less, e.g. 155 mg/L, 150 mg/L, 140 mg/L, 130 mg/L, 110 mg/L, 80 mg/L, 60 mg/L, 50 mg/L, 40 mg/L, 30 mg/L, 20 mg/L, 10 mg/L, 7 mg/L, 3 mg/L and the like, preferably 40-150 mg/L. A suitable ozone concentration combines with the illumination, making the photocatalytic ozonation reaction efficiently proceed.

Preferably, the ozone mixture comprises an ozone mixture produced by an oxygen source.

Preferably, when the silicon carbide material is used alone for photocatalytic ozonation treatment of wastewater, the amount thereof is 0.1-5 g/L, e.g. 0.3 g/L, 0.6 g/L, 0.8 g/L, 1.0 g/L, 1.5. g/L, 1.8 g/L, 2.0 g/L, 2.3 g/L, 2.6 g/L, 2.9 g/L, 3.3 g/L, 3.6 g/L, 3.8 g/L, 4.0 g/L, 4.3 g/L, 4.6 g/L, 4.8 g/L and the like, preferably 0.2-1 g/L.

When the silicon carbide material is used alone for photocatalytic ozonation treatment of wastewater, and the amount thereof is 0.1-5 g/L, the amount of ozone is preferably 20-150 mg/L, e.g. 25 mg/L, 40 mg/L, 65 mg/L. 80 mg/L, 95 mg/L, 102 mg/L, 115 mg/L, 125 mg/L, 135 mg/L, 145 mg/L and the like, the wavelength of the incident light is 200-420 nm.

The second object of the present disclosure is to provide a catalyst for photocatalytic ozonation comprising silicon carbide material.

The catalyst that the present disclosure provides comprises a silicon carbide material capable of responding to photocatalytic ozonation under visible light, expanding the wavelength of incident light of photocatalytic ozonation. In addition, since the silicon carbide material has good stability and high photocatalytic ozonation activity, the activity of the catalyst for photocatalytic ozonation is improved.

Preferably, when the silicon carbide material is compounded with any one selected from the group consisting of metallic simple substances and/or metal oxides, the content of the silicon carbide material in the ozone catalyst is 95 wt % or more, e.g. 96 wt %, 97 wt %, 98 wt. %, 99 wt %, 99.5 wt % and the like, preferably 95-99.9 wt %.

Preferably, the metallic simple substances and/or metal oxides are doped on the surface of the silicon carbide material.

The present disclosure has no specific limit to the metallic simple substances and/or metal oxides, exemplarily any one selected from the group consisting of palladium, platinum, gold, silver, ruthenium, rhodium, iridium, manganese, copper, iron, cobalt, nickel, and a combination of at least two selected therefrom.

Preferably, when the silicon carbide material is supported on a carrier, the content of the silicon carbide material in the ozone catalyst is 5-50 wt %, e.g. 6 wt %, 9 wt %, 12 wt %, 18 wt %, 25 wt %, 28 wt %. 35 wt %, 38 wt %, 45 wt %, 48 wt % and the like, preferably 10-40 wt %.

Preferably, the carrier comprises any one selected from the group consisting of titanium dioxide, zinc oxide, tungsten trioxide, nickel foam, and a combination of at least two selected therefrom.

The third object of the present disclosure is to provide a reactor for photocatalytic ozonation, in which the catalytic unit of the reactor for photocatalytic ozonation contains silicon carbide material.

Preferably, the catalytic unit of the reactor for photocatalytic ozonation contains the catalyst for photocatalytic ozonation as stated in the second object.

Preferably, the light source of the photocatalytic ozonation reactor comprises a light source capable of emitting ultraviolet light and/or visible light, preferably comprising a light source capable of emitting any light selected from the group consisting of ultraviolet light with a wavelength range of 10-400 nm, visible light with a wavelength range of 400-820 nm, full-wavelength incident light with a wavelength range of 10-820 nm, and simulated sunlight with a wavelength of 190-800 nm.

The catalyst for photocatalytic ozonation provided by the second object of the present disclosure and/or the reactor for photocatalytic ozonation provided by the third object can be not only used for wastewater treatment, degrading organics in wastewater, decolorizing, defoaming and sterilizing wastewater, but also used for exhaust gas and/or atmospheric treatment, to achieve the purpose of volatile organics removal, sterilization and deodorization.

As compared to the existing technologies, the present disclosure has the following beneficial effects:

(1) Instead of generally using silicon carbide material as a semiconductor, the present disclosure provides a new use of silicon carbide material as a catalyst for photocatalytic ozonation reaction, in which the catalyst has wider range of sources and excellent stability, reducing the cost of photocatalytic ozonation, and prolonging the life of catalyst for photocatalytic ozonation or the equipment thereof.

(2) The present disclosure provides a catalyst for photocatalytic ozonation comprising silicon carbide material, which has photocatalytic ozonation activity under visible light, showing high reactivity and good stability, so as to expand the range of incident light and reduce the catalyst dosage. In other words, the catalyst for photocatalytic ozonation comprising silicon carbide material shows higher reaction rate and longer life than traditional catalysts in the same amount.

(3) By using the silicon carbide material for photocatalytic ozonation reaction, the present disclosure overcomes the problem of low photocatalytic efficiency of silicon carbide, utilizes photogenerated electrons therefrom with strong reducibility to reduce ozone molecules to efficiently produce hydroxyl radicals, so as to improve the oxidation capacity in the process. Whether visible light or ultraviolet light is coupled with ozone, the group has strong catalytic activity, moreover, the silicon carbide has low cost and good stability, which prolongs the life of catalyst for photocatalytic ozonation or device.

### BRIEF DESCRIPTION OF THE DRAWINGS

FIG. 1 shows the degradation curve of p-hydroxybenzoic acid in Example 1 of the present disclosure.

FIG. 2 shows the TOC removal rate in Example 1 of the present disclosure.

FIG. 3 shows the TOC removal rate in Example 2 of the present disclosure.

FIG. 4 shows the degradation curve of oxalic acid in Example 3 of the present disclosure.

FIG. 5 shows the TOC removal rate in Example 4 of the present disclosure.

### DETAILED DESCRIPTION

In order to better understand the present disclosure, the present disclosure lists the following examples. Those skilled in the art should know that the examples are just used for understanding the present disclosure, and shall not be deemed as specific limits to the present disclosure.

### Example 1

A method for removing p-hydroxybenzoic acid from organic wastewater by UV light photocatalytic ozonation, comprising the following steps:

400 mL of p-hydroxybenzoic acid with an initial concentration of 40 mg/L was added into a semi-continuous reactor as a reaction solution, and an externally-lit xenon light source was set vertically above the reactor, the visible light region was filtered by a filter to make the light source emit only ultraviolet light with a wavelength range of 190-400 nm and a light intensity of 160 mW/cm²; the flow rate of ozone mixture was set as 100 mL/min, and the ozone concentration was set as 20 mg/L. 80 mg of silicon carbide as a catalyst was weighted and added into the reaction solution, so that the concentration of silicon carbide reached 0.2 g/L. The solid and liquid were thoroughly mixed, then the ultraviolet light source was turned on and the ozone mixture was continuously introduced into the reactor at the same time. During 1 hour of reaction, samples for different time periods were kept, subsequently the concentration of the reactant p-hydroxybenzoic acid was measured by high performance liquid chromatography, and the concentration of the total organic carbon (TOC) was measured by total organic carbon analyzer.

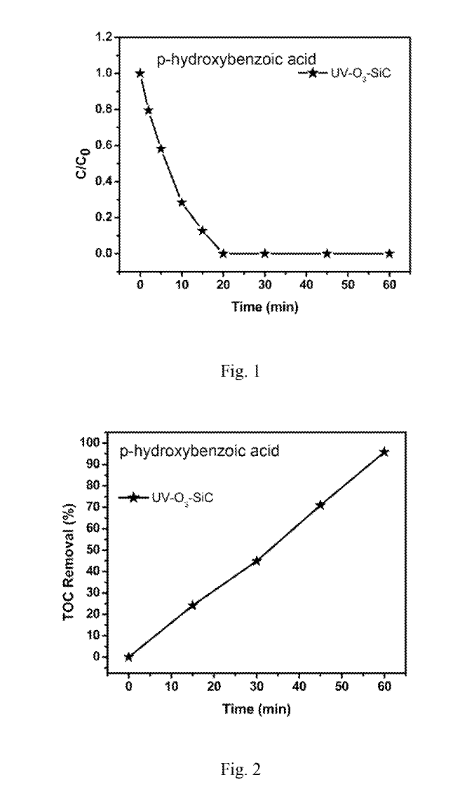

FIG. 1 shows the degradation curve of p-hydroxybenzoic acid in Example 1 of the present disclosure. FIG. 2 shows the TOC removal rate in Example 1 of the present disclosure. It can be seen from FIG. 1 that p-hydroxybenzoic acid was completely removed after 20 min of reaction; it can be seen from FIG. 2 that the removal rate of TOC reached 95.8% after 1 h of reaction, indicating that most of p-hydroxybenzoic acid is completely mineralized into water and carbon dioxide, achieving excellent effect of deep oxidation removal.

Subsequently, the catalyst was taken out, and the above experiment was repeated, then the catalytic activity of the catalyst after 10 cycles of use was measured (i.e., the steps of removing p-hydroxybenzoic acid was repeated, and the TOC removal rate was measured.). The result shows that the catalytic activity decreased by less than 0.2%.

### Example 2

A method for removing penicillin (Penicillin G) from medical wastewater by visible-light photocatalytic ozonation, comprising the following steps:

a reaction solution with an effective volume of 150 mL and an initial concentration of penicillin of 36 mg/L was contained in a cylindrical continuous reactor with silicon carbide coated on its inner wall; plug-in visible light source with a wavelength range of 420-800 nm and a light intensity of 130 mW/cm² was used, and the distance between the outer wall of the light source and the inner wall of the reactor was set as 1 cm. The flow rate of ozone mixture was set as 100 mL/min, and the ozone concentration was set as 20 mg/L. The simulated wastewater was introduced into the reactor, then the visible light source was turned on and the ozone mixture was continuously introduced into the reactor at the same time. The flow rate of the wastewater to be treated was adjusted to control the effective residence time in the reactor for 1 hour. Subsequently, the concentration of penicillin in the solution at the outlet was measured by high performance liquid chromatography, and the concentration of the TOC in the solution at the outlet was measured by total organic carbon analyzer.

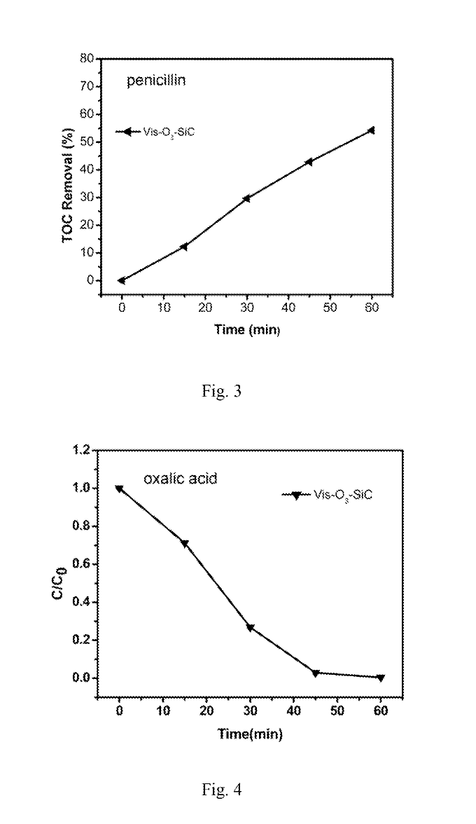

FIG. 3 shows the TOC removal rate in Example 2 of the present disclosure. It can be seen from FIG. 3 that the TOC removal rate reached 54.3% after 1 hour of reaction, indicating that most of the intermediate products were completely mineralized into water and carbon dioxide.

Subsequently, the catalyst was taken out, and the above experiment was repeated, then the catalytic activity of the catalyst after 10 cycles of use was measured (i.e., the steps of decomposing penicillin was repeated, and the TOC removal rate was measured.). The result shows that the catalytic activity decreased by less than 0.2%.

### Example 3

A method for removing oxalic acid from organic wastewater by visible-light photocatalytic ozonation, comprising the following steps:

300 mL of reaction solution with an initial concentration of oxalic acid of 180 mg/L was added into a semi-continuous reactor; and an externally-lit xenon light source was set vertically above the reactor, the ultraviolet light region was filtered by a filter to make the light source emit only visible light with a wavelength range of 420-800 nm and a light intensity of 490 mW/cm²; the flow rate of ozone mixture was set as 100 mL/min, and the ozone concentration was set as 20 mg/L. 60 mg of silicon carbide as a catalyst was weighted and added into the reaction solution, so that the concentration of silicon carbide reached 0.2 g/L. The solid and liquid was thoroughly mixed, then the visible light source was turned on and the ozone mixture was continuously introduced into the reactor at the same time. During 1 hour of reaction, samples for different time periods were kept, subsequently the concentration of oxalic acid was measured by high performance liquid chromatography.

FIG. 4 shows the degradation curve of oxalic acid in Example 3 of the present disclosure. It can be seen from the figure that almost all of oxalic acid was degraded after 45 minutes of reaction. Though oxalic acid is an intermediate product of degradation of most organics and is hard to be oxidized by ozone, the aforesaid method has a high degradation rate of oxalic acid, indicating that it has an excellent effect on the deep oxidation of organics.

Subsequently, the catalyst was taken out, and the above experiment was repeated, then the catalytic activity of the catalyst after 10 cycles of use was measured (i.e., the steps of decomposing oxalic acid was repeated, and the removal rate of oxalic acid was measured.). The result shows that the catalytic activity decreased by less than 0.1%.

### Example 4

A method for removing cefalexin from organic wastewater by sunlight photocatalytic ozonation, comprising the following steps:

400 mL of reaction solution with an initial concentration of cefalexin of 37 mg/L was added into a semi-continuous reactor; and an externally-lit xenon light source was set vertically above the reactor, wherein the wavelength range was set as 190-800 nm (simulated solar wavelength) and the light intensity was set as 200 mW/cm²; the flow rate of ozone mixture was set as 100 mL/min, and the ozone concentration was set as 30 mg/L. 80 mg of silicon carbide as a catalyst was weighted and added into the reaction solution, so that the concentration of silicon carbide reached 0.2 g/L. the solid and liquid was thoroughly mixing, then the simulated sunlight source was turned on and the ozone mixture was continuously introduced into the reactor at the same time. During 1 hour of reaction, samples for different time periods were kept, subsequently the concentration of cefalexin was measured by high performance liquid chromatography, and the concentration of the TOC was measured by total organic carbon analyzer.

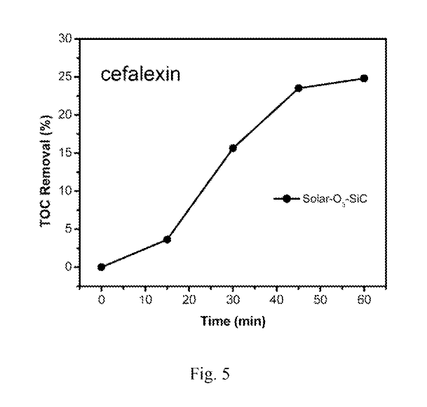

The results of high performance liquid chromatography show that cephalexin rapidly degraded after 5 min of reaction, so the degradation curve was not listed. FIG. 5 shows the TOC removal rate in Example 4 of the present disclosure. It can be seen from FIG. 5 that the TOC removal rate reached 25% after 1 hour of reaction. In fact, Example 4 provides a new concept for utilizing solar catalytic degradation. The mineralization degree of contaminant can be possibly further improved if conditions are optimized.

Subsequently, the catalyst was taken out, and the above experiment was repeated, then the catalytic activity of the catalyst after 10 cycles of use was measured (i.e., the steps of decomposing cephalexin was repeated, and the removal rate of oxalic acid was measured.). The result shows that the catalytic activity decreased by less than 0.1%.

### Example 5

A method for treating pharmaceutical wastewater by visible-light photocatalytic ozonation, comprising the following steps:

400 mL of pharmaceutical wastewater with an initial COD concentration of 260 mg/L was added into a semi-continuous reactor; and an externally-lit xenon light source was set vertically above the reactor, wherein the wavelength range was set as 190-800 nm (simulated solar wavelength) and the light intensity was set as 200 mW/cm²; the flow rate of ozone mixture was set as 100 mL/min, and the ozone concentration was set as 30 mg/L. The catalyst was a composite material in which silicon carbide and carbon nitride were composited in a mass ratio of 1:1. 400 mg of the catalyst was weighted and added into the reaction solution, so that the concentration of the catalyst reached 1 g/L. The solid and liquid was thoroughly mixed, then the light source was turned on and the ozone mixture was continuously introduced into the reactor at the same time. After 1 hour of reaction, the COD concentration was measured.

After 1 hour of reaction, the COD concentration of the pharmaceutical wastewater was reduced to 127 mg/L, and the effect was significant. Subsequently, the catalyst was taken out, and the above experiment was repeated, then the catalytic activity of the catalyst after 10 cycles of use was measured (i.e., the steps of reducing COD was repeated, and the removal rate of TOC was measured.). The result shows that the catalytic activity decreased by less than 0.1%.

### Example 6

A method for treating the biochemical effluent of papermaking wastewater by UV light photocatalytic ozonation, comprising the following steps: 400 mL of biochemical effluent of papermaking wastewater with an initial COD concentration of 80 mg/L was added into a semi-continuous reactor; and an externally-lit xenon light source was set vertically above the reactor, the visible light region was filtered by a filter to make the light source emit only ultraviolet light with a wavelength range of 190-400 nm and a light intensity of 160 mW/cm²; the flow rate of ozone mixture was set as 100 mL/min, and the ozone concentration was set as 160 mg/L. 2 g of silicon carbide as a catalyst was weighted and added into the reaction solution, so that the concentration of silicon carbide reached 5 g/L. the solid and liquid was thoroughly mixed, then the ultraviolet light source was turned on and the ozone mixture was continuously introduced into the reactor at the same time. After 1 hour of reaction, the COD concentration was measured.

After 1 hour of reaction, the COD concentration of the reaction solution was reduced to 37 mg/L, indicating that most of organics were completely mineralized into water and carbon dioxide, showing an excellent effect on deep oxidation removal.

Subsequently, the catalyst was taken out, and the above experiment was repeated, then the catalytic activity of the catalyst after 10 cycles of use was measured (i.e., the steps of reducing COD was repeated, and the removal rate of TOC was measured.). The result shows that the catalytic activity decreased by less than 0.2%.

### Comparison Example 1

A method for removing oxalic acid from simulated wastewater by silicon carbide-ultraviolet photocatalysis, comprising the following steps:

300 mL of simulated wastewater with an initial concentration of oxalic acid of 180 mg/L was added into a semi-continuous reactor; and an externally-lit xenon light source was set vertically above the reactor, the visible light region was filtered by a filter to make the light source emit only ultraviolet light with a wavelength range of 190-400 nm and a light intensity of 160 mW/cm². 80 mg of silicon carbide as a catalyst was weighted and added into the reaction solution, so that the concentration of silicon carbide reached 0.2 g/L. The solid and liquid was thoroughly mixed, then the ultraviolet light source was turned on. After 1 hour of reaction, the concentration of oxalic acid was measured by high performance liquid chromatography.

After 1 hour of reaction, the removal rate of oxalic acid in the solution was only 3.5%, indicating that the ultraviolet photocatalytic activity of silicon carbide was very low.

### Comparison Example 2

A method for removing oxalic acid from simulated wastewater by silicon carbide visible-light photocatalysis, comprising the following steps:

The experimental conditions were the same as those of Comparative Example 1, except that the light source was changed to visible light with a wavelength range of 420-800 nm and a light intensity of 490 mW/cm².

After 1 hour of reaction, the removal rate of oxalic acid in the solution was only 2.8%, indicating that the visible-light photocatalytic activity of the silicon carbide was very low.

### Comparison Example 3

A method for removing oxalic acid from simulated wastewater by using silicon carbide catalytic ozonation, comprising the following steps:

300 mL of simulated wastewater with an initial concentration of oxalic acid of 180 mg/L was added into a semi-continuous reactor; the flow rate of ozone mixture was set as 100 mL/min, and the ozone concentration was set as 20 mg/L. 80 mg of silicon carbide as a catalyst was weighted and added into the reaction solution, so that the concentration of silicon carbide reached 0.2 g/L. The solid and liquid was thoroughly mixed. After 1 hour of reaction, the concentration of oxalic acid was measured by high performance liquid chromatography.

After 1 hour of reaction, the removal rate of oxalic acid in the solution was only 4.1%, indicating that the catalytic ozonation activity of silicon carbide was very low.

From the results of Comparative Examples 1 to 3 and Example 3, it can be seen that when silicon carbide is used as a catalyst, the removal effect of oxalic acid in the wastewater is very poor when pure light only (including ultraviolet, visible light) or ozone condition only is used, with a removal rate of 5% or less. While silicon carbide is used as a catalyst for photocatalytic ozonation, almost all of the oxalic acid in the wastewater can be removed (99% or more), obtaining an unexpected technical effect. Moreover, silicon carbide exhibits excellent effects on the removal of other pollutants in wastewater when used as a catalyst for photocatalytic ozonation, e.g., the catalytic removal rate of p-hydroxybenzoic acid in organic wastewater is 95% or more, and the catalyst activity decreases by 0.2% or less; as to removing penicillin and cephalexin from pharmaceutical wastewater, most of the intermediate products can be degraded after 1 hour of catalysis; and oxalic acid in organic wastewater can be almost completely degraded for 45 minutes of catalysis.

The applicant declares that the present disclosure discloses the process via the aforesaid examples. However, the present disclosure is not limited by the aforesaid process steps. That is to say, it does not mean that the present disclosure cannot be carried out unless the aforesaid process steps are carried out. Those skilled in the art shall know that any improvement, equivalent replacement of the parts of the present disclosure, addition of auxiliary parts, selection of specific modes and the like all fall within the protection scope and disclosure scope of the present disclosure.

What is claimed is:

1. A method for photocatalytic ozonation reaction, in which the method comprises: under the condition of illumination, using a substance comprising silicon carbide material as a catalyst, bringing the substance into contact with wastewater and/or exhaust gas, and at the same time, introducing a gas comprising ozone to carry out a reaction.

2. The method according to claim 1, in which the incident light of the illumination comprises any one selected from the groups consisting of ultraviolet light with a wavelength range of 10-400 nm, visible light with a wavelength range of 400-820 nm, full-wavelength incident light with a wavelength range of 10-820 nm, and simulated sunlight with a wavelength range of 190-800 nm.

3. The method according to claim 1, in which the incident light of the illumination is of continuous-wavelength incident light or single-wavelength incident light.

4. The method according to claim 1, in which the catalyst further includes a dopant.

5. The method according to claim 4, in which the dopant includes any one selected from the group consisting of metallic simple substances, metal oxides, silicon carbide, bismuth vanadate, and a combination of at least two selected therefrom.

6. The method according to claim 5, in which the metal in the metallic simple substances or the metal oxides comprises any one selected from the group consisting of palladium, platinum, gold, silver, ruthenium, rhodium, iridium, manganese, copper, iron, cobalt, nickel, chromium, vanadium, molybdenum, titanium, zinc, tungsten, tin, and a combination of at least two selected therefrom.

7. The method according to claim 5, in which the metallic simple substances or the metal oxides are doped on the surface of the silicon carbide material.

8. The method according to claim 1, in which the silicon carbide material exists in the form of anyone selected from the group consisting of a porous silicon carbide material sintered from solid silicon carbide powder, silicon carbide powder supported on the surface of a solid carrier, silicon carbide powder coated on the inner wall of a reactor, silicon carbide powder, and a combination of at least two selected therefrom.

9. The method according to claim 8, in which the silicon carbide powder material comprises any one selected from the group consisting of solid silicon carbide powder, mesoporous silicon carbide, silicon carbide nanorods, silicon carbide hollow spheres, and a combination of at least two selected therefrom.

10. The method according to claim 1, in which the method for preparing the silicon carbide material comprises any one selected from the group consisting of a template method, a sol-gel method, a carbothermic reduction method, a polycarbosilane cleavage method, a chemical vapor deposition method, a high-temperature thermal evaporation method, a combustion method, and a combination of at least two selected therefrom.

11. The method according to claim 1, in which the gas comprising ozone comprises ozone mixture, wherein the ozone mixture has an ozone concentration of 160 mg/L or less.

12. The method according to claim 11, in which the ozone mixture comprises an ozone mixture produced by an oxygen source.

13. The method according to claim 1, in which when the silicon carbide material is used alone for photocatalytic ozonation treatment of wastewater, the amount thereof is 0.1-5 g/L.

14. A catalyst for photocatalytic ozonation comprising silicon carbide material.

15. The catalyst for photocatalytic ozonation according to claim 14, in which when the silicon carbide material is compounded with any one selected from the group consisting of metallic simple substances and/or metal oxides, the content of the silicon carbide material in the ozone catalyst is 95 wt % or more.

16. The catalyst for photocatalytic ozonation according to claim 15, in which the metallic simple substances and/or metal oxides are doped on the surface of the silicon carbide material.

17. The catalyst for photocatalytic ozonation according to claim 14, in which when the silicon carbide material is supported on a carrier, the content of the silicon carbide material in the ozone catalyst is 1-60 wt %.

18. A reactor for photocatalytic ozonation, in which the catalytic unit of the reactor for photocatalytic ozonation contains silicon carbide material.

19. The reactor for photocatalytic ozonation according to claim 18, in which the catalytic unit of the reactor for photocatalytic ozonation contains the catalyst for photocatalytic ozonation according to claim 14.

20. The reactor for photocatalytic ozonation according to claim 20, in which the light source of the reactor for photocatalytic ozonation comprises a light source capable of emitting any light selected from the group consisting of ultraviolet light with a wavelength range of 10-400 nm, visible light with a wavelength range of 400-820 nm, full-wavelength incident light with a wavelength range of 10-820 nm, and simulated sunlight with a wavelength of 190-800 nm.
